(19) United States
(12) Patent Application Publication
(10) Pub. No.: US 2006/0057272 A1
(43) Pub. Date: Mar. 16, 2006

(54) Use of cryogenic cocoa butter for tempering chocolate

(75) Inventors: Philippe Bertrand, Bailly (FR); Philippe Marand, Plaisir (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Barry Callebaut AG

(21) Appl. No.: 10/937,605

(22) Filed: Sep. 10, 2004

(51) Int. Cl. A23G 1/00

(52) U.S. Cl. 426/593

(57) ABSTRACT

A process for tempering chocolate comprising adding cryogenic cocoa butter to melted chocolate and mixing until the cryogenic cocoa butter is melted.

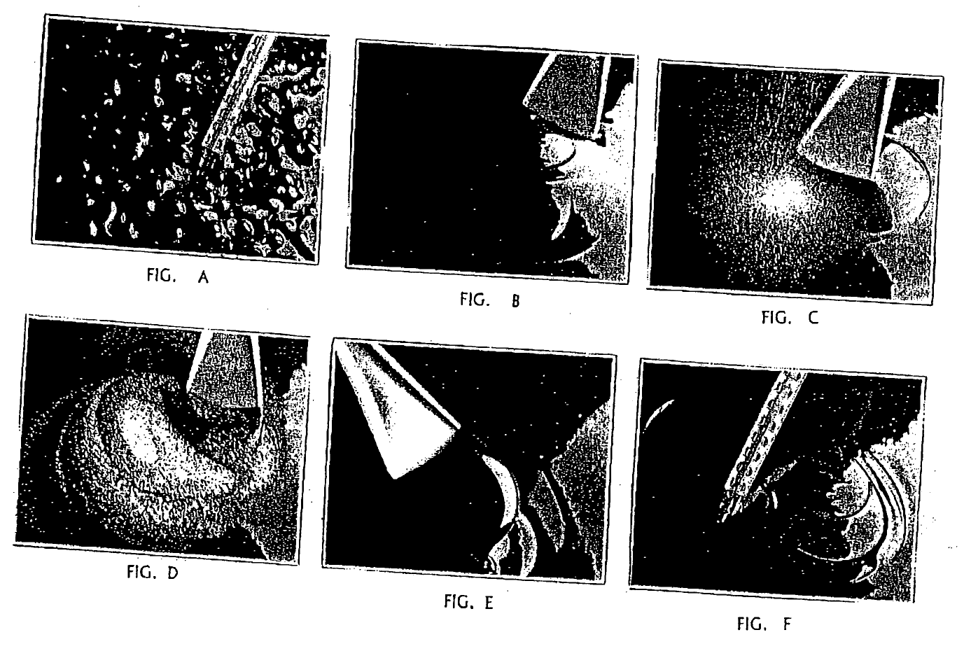

The present invention relates to the use of cryogenic cocoa butter for tempering chocolate.

Tempering is an unavoidable step in creating the ideal chocolate.

Tempering can be defined as a thermal and mechanical procedure of crystallization orientation, by selecting the most stable crystals.

Stable Beta crystal seeds are created in the melted chocolate, which will help a proper crystallization of the entire cocoa butter later during cooling.

For a successful tempering, these stable crystal seeds have to be created. This is called the pre-crystallization phase. Pre-crystallization depends not only on the temperature at which the product is set, but also the duration of this temperature change, and the agitation to which the product is subjected. This agitation does in fact incur thermal changes within the chocolate, which can be detrimental to a good tempering.

The quantity of crystal seeds created is also important. In fact, if there aren't enough seeds of stable Beta crystals, the non-molded chocolate surface will have a grainy texture after solidification. This is called under-tempering.

If there are too many crystal seeds, the turning out will be far more difficult. A white film can also occur. This is called over-tempering.

It is thus essential to understand the criteria required for a successful tempering. This criteria may vary depending on the composition of the chocolate and the way of tempering used.

Traditionally, manual tempering is used by chocolatiers.

For manual tempering, the chocolate is heated to 40-45° C. (104-113° F.;. It is worked on a table of granite with a spatula and a metal scraper in order to reduce the temperature. For dark chocolate, it has to go down to about 28° C. (82.5° F.). For milk, white or colored chocolate, the temperature should be at 26° C. (79° F.). The chocolate then begins to thicken. The Beta crystals multiply in number. The mixture is then heated to 31-33° C. (88-91.5° F.) for dark chocolate and to 29-30° C. (84-86° F.) for white, milk and colored chocolates. The Beta crystals are then predominant.

It is therefore necessary to optimize the crystallization to:
Obtain a shiny surface on the chocolate with uniform color.
Avoid obtaining a grainy texture and an off-white appearance.
Make it easier to un-mould (the chocolate shrinks upon cooling and comes out of the un-mould more easily).
   Cryogenic Cocoa Butter for Chocolate Crystallization

By cryogenic cocoa butter, it is meant a cocoa butter crystallized in the beta form. For example, such a cocoa butter can be obtained by a process comprising the following steps:
obtaining cocoa butter in liquid form,
atomizing said liquid, and,
rapidly cooling the atomized liquid to form a powder.

Advantageously, such a cryogenic cocoa butter is in a powder form.

Such a process is for example described in PCT patent application WO 98/13133, which is incorporated by reference.

Cryogenic cocoa butter enables easy crystallization.

Method:
Add 0.3-1.2% cryogenic cocoa butter to chocolate melted at 34-35° C.
Mix until all the cryogenic cocoa butter is melted.

The chocolate is ready at temperatures between 31 and 32° C. for dark chocolate and between 28 and 30° C. for white, milk or colored chocolates.

In a particular embodiment of the invention, the chocolate is a couverture chocolate (at lens, 31% of cocoa butter in the chocolate).

This additional method has the advantage of being clean and accessible to all without needing a great knowledge of chocolate.

Tempering chocolate has become very simple thanks to cryogenic cocoa butter. Tempering by the traditional method is a rather complicated process. With cryogenic cocoa butter, it is very simple: the cryogenic cocoa butter powder is added once the chocolate has reached the proper temperature.

Moreover, by tempering with cryogenic cocoa butter, the chocolate also remains fluid longer.

The crystallization obtained by using method is ideal for:
Molding
Enrobing
Chocolate decoration.

The advantages of cryogenic cocoa butter are the followings:
In powder form to facilitate accurate and convenient measuring,
Fast and easy way to achieve quality crystallization every time,
100% cocoa butter

Storage:
Shelf-life: 1 year unopened (in general 1.5 Da (3 lbs) canister package)
Keep cool at 12-18° C. (54-64° F.)

The characteristics and advantages of the present invention are illustrated by the following examples, with reference to FIGS. A to F.

### EXAMPLE 1

### Crystallization of Dark Couverture Chocolate

Either working by hand or with an enrober.

Quantity: 1 kg
Melt dark chocolate at 40-45° C. (104-113° F.) (microwave or bain marie) (FIG. A)
Allow chocolate to cool at room temperature to 34-35° C. (93-95° F.) with mixing regularly (FIG. B)
Add 1% of cryogenic cocoa butter by sifting, i.e. 10 g for 1 kg of chocolate. (FIG. C)
Mix well (FIG. D)
When the chocolate reaches, 31-32° C. (88-90° F.), it can be used for the final product application (molding, enrobing, chocolate decoration) (FIG. E)
When using the chocolate over a longer period of time, keep it at 31-32° C. (88-90° C.) (FIG. F)

### EXAMPLE 2

### Crystallization of Milk, White or Colored Chocolate

Quantity: 1 kg
Melt chocolate at 40-45° C. (104-113° F.) (microwave or bain marie) (FIG. A)
Allow the chocolate to cool at room temperature to 34-35° C. (93-95° F.) with mixing regularly (FIG. B)
Add 1% of cryogenic cocoa butter by sifting, i.e. 10 g for 1 kg of chocolate (FIG. C)
Mix well (FIG. D)
When the chocolate reaches 29-30° C. (84-86° F.), it can be used for the final product application (molding, enrobing, chocolate decoration) (FIG. E)
When using the chocolate over a longer period of time, keep it at 29-30° C. (84-86° F.) (FIG. F)

1. A process for tempering chocolate comprising the steps of:
a) Adding 0.3-1.2%, cryogenic cocoa butter to chocolate melted at 34-35° C. and,
b) Mixing until all the cryogenic cocoa butter is melted.

2. A process for tempering chocolate according to claim 1, wherein chocolate is dark chocolate, further comprising the step of:
c) Using chocolate for the final product application when the chocolate reaches 31-32° C.

3. A process for tempering chocolate according to claim 1, wherein chocolate is milk, white or colored chocolate further comprising the step of:
c) Using chocolate for the final product application when the chocolate reaches 29-30° C.

4. A process according to any of preceding claims, wherein the chocolate is a couverture chocolate.
